(19) United States
(12) Patent Application Publication
(10) Pub. No.: US 2026/0186478 A1
(43) Pub. Date: Jul. 2, 2026

(54) DETECTING LIQUID LEAKAGE IN A COMPUTING DEVICE

(71) Applicant: Aivres Systems Inc., Fremont, CA (US)

(72) Inventors: Hongji ZHENG, New Taipei City (TW); Mingduo KAO, New Taipei City (TW)

(21) Appl. No.: 19/546,654

(22) Filed: Feb. 23, 2026

(51) Int. Cl. G05B 23/02; G01M 3/16

(52) U.S. Cl. CPC G05B 23/0221; G01M 3/165

(57) ABSTRACT

Methods, systems, and apparatus, including computer programs encoded on computer storage media, for detecting liquid leakage. An example method includes: receiving, by a control circuit of a control system, a first signal generated based on data associated with a sensing element in the control system, wherein the first signal indicates liquid leakage is detected in a computing device; switching, by the control circuit, the control system from a first output path to a second output path, wherein the second output path connects to an analog-to-digital converter of the control system; generating, by the analog-to-digital converter and based on the data, a second signal to the control circuit; and determining, by the control circuit and based on the second signal, an action to be performed by the computing device.

### TECHNICAL FIELD

The present disclosure is related to computing devices and systems.

### BACKGROUND

Computing devices, such as servers, are widely deployed across numerous fields. With the rapid growth of machine learning, artificial intelligence, and other high-performance computing applications, the demand for such devices continues to increase. Many computing devices include numerous printed circuit board (PCB) components and/or high-performance electronic components (e.g., processors and memory modules) that consume substantial electrical power and generate significant heat, which must be dissipated to maintain safe and reliable operating conditions.

For instance, a computing device for AI applications may incorporate one or more central processing units (CPUs) and/or graphical processing units (GPUs), while a storage server may include one or more non-volatile memory devices. To manage the resulting thermal load, such systems may employ one or more cooling devices, including air-cooling devices, liquid-cooling devices, or combinations thereof. However, when a liquid-cooling device malfunctions and results in fluid leakage, the leaked fluid may damage electronic components, printed circuit boards, or other system hardware, thereby impairing the reliability and safety of the computing device.

### SUMMARY

The present disclosure describes systems, devices, circuits, methods, and techniques for automatically detecting liquid leakage in a computing device.

One aspect of the present disclosure features a method, including receiving, by a control circuit of a control system, a first signal generated based on data associated with a sensing element in the control system. The first signal indicates that liquid leakage is detected in a computing device. The method further includes switching, by the control circuit, the control system from a first output path to a second output path. The second output path connects to an analog-to-digital converter of the control system. The method also includes generating, by the analog-to-digital converter and based on the data, a second signal to the control circuit. The method additionally includes determining, by the control circuit and based on the second signal, an action to be performed by the computing device.

In some implementations, the method may further include causing the computing device to perform the action. The action may include one or more of (i) maintaining current operations of the computing device or shutting down the computing device, (ii) storing information related to the data, the first signal, the second signal, or the action into a log file, and (iii) generating a warning signal.

In some implementations, the first signal may be generated by an event-controller of the control system. The event-controller may be configured to maintain the first signal for a time period. The method may further include, in response to determining that a value of the data is below a threshold value, generating the first signal by the event-controller.

In some implementations, the method may further include: in response to determining that a value of the data is equal to or above a threshold value, generating, by the event-controller, a third signal that represents no detection of liquid leakage in the computing device.

In some implementations, the sensing element may include a liquid leakage sensor cable, and the data may include a resistance value of the liquid leakage sensor cable enclosed by a housing of the computing device.

The method may further include: after determining the action to be performed by the computing device, switching the control system from connecting to the second output path back to connecting to the first output path.

To determine the action to be performed by the computing device, the method may include: generating a comparison result by comparing the second signal with one or more threshold status values, and determining a classification of liquid leakage from among a plurality of classifications of liquid leakage based on the comparison result. Each of the plurality of classifications of liquid leakage corresponds to one of the one or more threshold status values. The method may also include determining the action that corresponds to the classification of liquid leakage to be performed by the computing device.

Another aspect of the present disclosure features a system, including one or more computers and one or more storage devices storing instructions that, when executed by one or more computers, cause the one or more computers to perform respective operations similar to those described above with respect to the method.

Another aspect of the present disclosure features one or more non-transitory computer-readable storage media storing instructions that, when executed by one or more computers, cause the one or more computers to perform respective operations similar to those described above with respect to the method.

Another aspect of the present disclosure features an apparatus, including: a sensing element coupled to at least a portion of a computing device, and a switch coupled to the sensing element. The switch is configured to initially connect the sensing element to a first output path and then switch between the first output path and a second output path. The apparatus further includes an analog-to-digital converter coupled to the second output path, and a controller (or a control circuit) configured to: receive a first signal generated based on data associated with the sensing element, wherein the first signal indicates that liquid leakage is detected in the computing device, cause the switch that initially connects the sensing element to the first output path to switch from connecting to the first output path to connecting the second output path, receive a second signal generated by the analog-to-digital converter based on the data, and determine, based on the second signal, an action to be performed by the computing device.

The apparatus may further include an event-controller configured to generate the first signal in response to determining that a value of the data is below a threshold value. The event-controller may be configured to maintain the first signal for a time period.

In some implementations, the event-controller may be configured to generate a third signal that represents no detection of liquid leakage in the computing device in response to determining that a value of the data is equal to or above a threshold value.

In some implementations, the sensing element may include a liquid leakage sensor cable, and the data may include a resistance value of the liquid leakage sensor cable enclosed by a housing of the computing device.

The controller may be further configured to cause the switch to switch from connecting to the second output path back to connecting to the first output path after determining the action to be performed by the computing device.

To determine the action, the controller may be configured to generate a comparison result by comparing the second signal with one or more threshold status values, and determine a classification of liquid leakage from among a plurality of classifications of liquid leakage based on the comparison result. Each of the plurality of classifications of liquid leakage corresponds to one of the one or more threshold status values. The controller may also be configured to determine the action that corresponds to the classification of liquid leakage to be performed by the computing device.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a schematic diagram of an example of a system including a computing system and one or more computing devices, wherein at least one computing device includes a control system for detecting liquid leakage in one or more computing devices.

FIG. 2 is a schematic diagram of an example of a computing device having a control system.

FIG. 3 is a flow diagram of an example process of detecting liquid leakage using the control system of FIG. 2.

FIG. 4 is a flow diagram of an example process of processing a converter output to determine an action to be performed by the computing device.

FIG. 5 illustrates an example computing device.

FIG. 6 illustrates an example computing system.

Like reference numbers and designations in the various drawings indicate like elements.

### DETAILED DESCRIPTION

The described techniques generally relate to efficiently detecting and characterizing liquid leakage within a computing device, e.g., originating from one or more liquid-cooling devices. To efficiently determine a leakage condition, the described techniques implement an analog-to-digital converter (ADC) configured to generate a converter output that classifies sensor data into one of multiple categories. The sensor data can relate to a resistance value or a voltage value associated with a detection unit (e.g., a resistor cable). Each category represents a respective degree/condition of liquid leakage in the computing device. A control circuit of the described techniques can determine an action corresponding to the classified category to be performed by the computing device.

In some implementations, the described techniques can employ a two-stage detection mechanism toggled by a switch. The two-stage detection mechanism includes a first stage for an initial, coarse detection, followed by a second stage for a more granular classification. In the first stage, a system implementing the described techniques uses the switch to initially connect with a comparator using a first output path of the switch. The comparator is configured to compare the sensor data (e.g., from a liquid leakage sensor element) with a predetermined threshold value. If the comparator determines that the sensor data indicates a value that satisfies the predetermined threshold (e.g., a voltage value is equal to or greater than a predetermined threshold voltage value, which indicates no liquid detection), the system maintains the current operations performed by the computing device and takes no additional actions.

Once the comparator determines that the sensor data does not satisfy the predetermined threshold value (e.g., a voltage value is smaller than a predetermined threshold voltage value, which indicates a potential leakage), the comparator outputs a signal that eventually causes the control circuit to change the switch from the first output path to connect with the second output path, which is communicatively coupled to the ADC. The ADC performs the granular classification into the leakage categories. After the control circuit determines the appropriate action to be performed by the computing device based on the converter output from the ADC (e.g., storing information in a log file, initiating shutdown of the computing device, triggering an alarm, or other suitable actions), the control circuit can reset the switch to reconnect with the first output path, communicatively coupled to the comparator, thereby preparing the system for subsequent initial monitoring.

A computing device can include multiple electronic components, which generate heat during operation. The amount of heat generated depends on the working load or power consumption of those electronic components. The generated heat can increase the ambient temperature of electronic components and other components in the computing device, which may adversely affect the performance and/or reliability of printed circuit boards (PCBs), corresponding electronic components, and the computing device. For example, excessive heat can accelerate the degradation of electronic components, reduce their performance, increase the computing device's power consumption, and cause system instability. To address the above-noted challenges, computing devices may employ one or more cooling devices, e.g., air cooling devices such as fans, liquid cooling devices such as fluid pumps and tubes, coolant distribution unit, cold plates, etc., or other cooling devices mounted on or near PCBs, nodes, and/or the computing device to circulate air, absorb excess heat, and promote heat dissipation to cool those electronic components and the computing device.

Liquid-cooling devices use pipes, channels, or conduits to circulate liquid (e.g., coolant) within a computing device. However, this circulating liquid may leak under various conditions. Such conditions can include, but are not limited to, malfunction of the cooling device, fatigue or cracking of pipes or channels due to prolonged use or aging, or loosening or degradation of a joint or connector between two or more conduits. Liquid leakage of various degrees can affect the computing device differently. For example, a minor liquid leakage or liquid condensation (e.g., from ambient air) may not significantly impair functionality. In contrast, substantial liquid leakage can cause short circuits and catastrophic damage to sensitive electronic components within the computing device.

In some cases, liquid leakage detection can involve implementing or a sensing element, which is measured by a sensor or can itself serve as a sensor, e.g., a liquid leakage sensor cable. This liquid leakage sensor cable typically comprises a string of conductive fibers or is deposited with a particular conductive coating that is sensitive to moisture. When the conductive fibers or coating contacts liquid, the electrical resistance value of the cable may decrease. In those cases, a system typically includes a specialized liquid detection controller or a relay module to convert this change in resistance value into a binary signal (e.g., a simple “leak” or “no leak” indication). This binary signal then dictates an action to be performed by the computing device, such as immediately shutting down the computing device to protect it from leakage damage. Note that in some implementations, the liquid leakage sensor cable can include materials that increase in electrical resistance when in contact with liquid. In those scenarios, the logic of determining leakage should be similar except that the criteria may be flipped, e.g., indicating leakage if the voltage of the liquid leakage sensor cable becomes greater than the threshold voltage value.

However, these conventional techniques suffer from several drawbacks. First, implementing specialized controllers, converters, and/or additional control boards increases the cost and complexity of manufacturing and maintenance for the computing device. Second, the granularity of the detection using binary signals is often too coarse. In particular, the resulting binary signal may be insufficient to distinguish between a harmless event, such as a slight resistance drop due to water condensation from the air, and a significant, damaging leak. This lack of granularity can sometimes lead to a false alarm that unnecessarily causes the computing device to shut down, resulting in unwanted system downtime and reduced availability. A need therefore exists for an improved, cost-effective system that can efficiently provide a finer, more reliable classification of liquid leakage severity.

Implementations of the present disclosure provide systems and techniques that can address the above-noted limitations of various techniques and realize one or more of the following technical advantages, effects, and/or benefits. The described system significantly enhances the granularity and accuracy of leakage detection. This is achieved by utilizing the analog-to-digital converter (ADC) to convert the analog sensor signal into one of a plurality of categorized digital outputs. The sensor data may be generated, for example, by detecting a voltage change via a voltage division method or by detecting a change in current intensity, both being responsive to a change in the resistance of a liquid leakage sensing element. This fine-grained classification enables the computing device to perform a nuanced, appropriate response (e.g., throttling operations of one or more electronic components, logging the leakage event, or initiating immediate shutdown), rather than an indiscriminate binary action (e.g., shutting down the entire computing device), thereby improving system reliability and uptime.

One further advantage lies in the highly efficient, two-stage detection mechanism employed by the described system. The first/initial stage utilizes a simple comparator for coarse detection to quickly determine the presence of a potential leakage event (a binary pre-screening). Only upon detection of a potential leak does the system activate the second stage, which uses the ADC for refined classification. This sequential approach conserves power and processing resources by only engaging the more complex, power-intensive ADC when the sensor data exceeds a certain threshold, thus ensuring high detection efficiency.

Furthermore, the described techniques can reduce power consumption and extend sensor lifespan. In some embodiments, the first (coarse detection) stage utilizes a Pulse Width Modulation (PWM) signal to generate the excitation for the sensor. Using PWM signals ensures the circuit is only closed and drawing power for short time intervals necessary for sampling. This intermittent operation significantly decreases overall power consumption, making the technique highly suitable for long-term, in situ monitoring. Additionally, the intermittent nature of the PWM signal inherently mitigates cable corrosion that could otherwise be induced by continuous high-voltage-level application, thereby extending the operational lifespan of the liquid leakage sensor cable.

Moreover, the described techniques offer cost-effective and seamless integration into various computing device architectures, including those with legacy designs. The control logic can be effectively combined with existing control circuits, such as a Baseboard Management Controller (BMC) or within a Power Distribution Board (PDB). This integration reduces the need for additional specialized control boards or converters, thereby lowering both manufacturing costs and the overall implementation challenges associated with adding the described leakage detection module to existing computing device designs.

A “liquid cooling device” described herein relates to a thermal management component or system that removes heat from one or more heat-generating electronic components in a server or computing device by circulating a liquid coolant through a closed or semi-closed loop. The device can include elements such as cold plates, heat exchangers or sinks, pumps, tubing, and heat radiators that transfer heat from the liquid coolant to the ambient air or a facility coolant loop. A liquid coolant can include water, liquid nitrogen, or any suitable coolant.

“Sensor data” described herein refers to an electrical signal or value that represents an electrical characteristic of a sensing element. The sensing element can be, but is not limited to, a liquid leakage sensor cable or other equivalent components designed to detect the presence of liquid. Sensor data may be obtained by using a sensor associated with a sensing element, e.g., using a resistance sensor to measure a resistance value of the liquid leakage sensor cable. That said, in some implementations, a sensing element can provide sensor data for a unit (e.g., a controller, a processor, a logic gate) to perform corresponding operations without explicitly requiring a sensor assigned to that sensing element. For example, in a closed circuit that includes a first electrical component and a liquid leakage sensor cable, a sensor associated with the first electrical component can measure electrical characteristics of the first electrical component, which can be used to derive electrical characteristics associated with the liquid leakage sensor cable, e.g., a voltage value of the liquid leakage sensor cable. As another example, the liquid leakage sensor cable in a closed circuit can itself serve as a “sensor” to provide data implicitly representing a voltage value or resistance value for a comparator circuit to perform respective operations.

In some implementations, the sensor data can reflect a change in the electrical characteristics, particularly when the sensing element contacts a liquid, which may include, for example, water condensed from the ambient air, or a coolant leak originating from one or more liquid cooling devices within the computing device. The sensor data may provide an analog metric corresponding to the degree of liquid exposure experienced by the sensing element. The specific electrical characteristic monitored by the sensor data may include, without limitation, the electrical resistance of the liquid leakage sensing element, the voltage measured across the sensing element, the electrical current passing through the sensing element when placed in a closed detection circuit, or other suitable values for various detection requirements.

“Electronic components” described herein can include, but are not limited to, devices or modules configured to perform computing, storage, communication, or power management functions within a computing device. Such electronic components may be designed to process data, manage memory operations, regulate power distribution, or facilitate input/output operations. Examples of the electronic components can include one or more central processing units (CPUs), one or more graphics processing units (GPUs), or one or more memory units (e.g., dynamic random-access memory (DRAM), static random-access memory (SRAM), non-volatile memory devices such as NVMe drives, or other memory modules). Additional examples include storage devices (e.g., solid-state drives or hard disk drives), network interface controllers (NICs), field-programmable gate arrays (FPGAs), application-specific integrated circuits (ASICs), power management modules, input/output (I/O) controllers, voltage regulators, and accelerators for artificial intelligence or machine learning tasks. For simplicity, the terms “electronic components” and “components” may be used interchangeably to broadly refer to any of those modules described above, integrated within or coupled to a computing device.

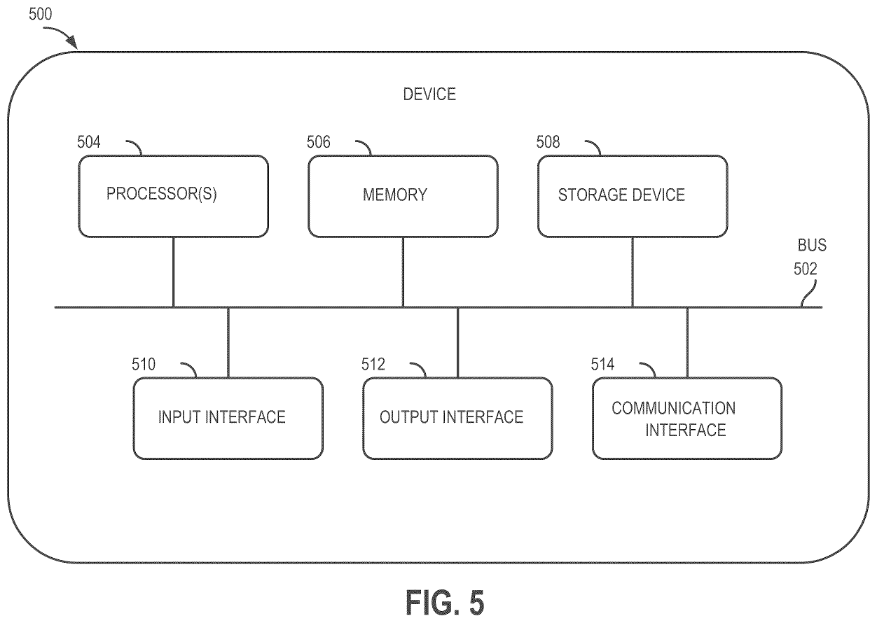

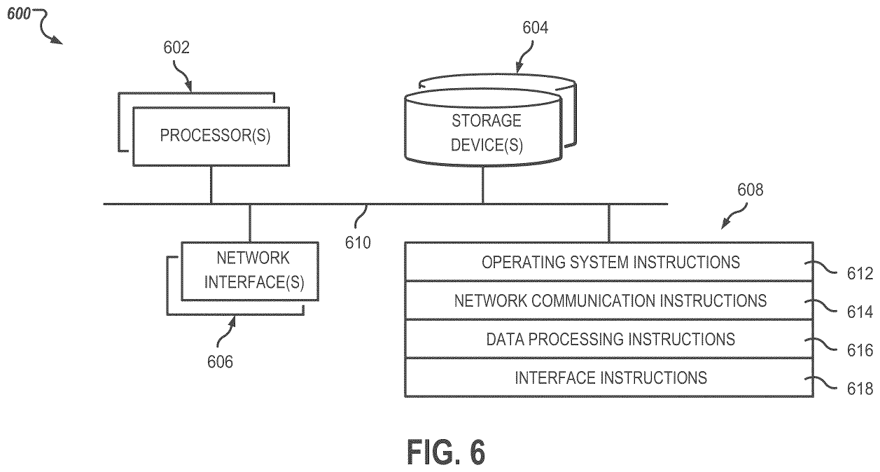

“Computing device(s)” described herein can include one or more computing devices or user devices, such as a server, a personal computer, a laptop, a cellphone, a smart watch, a smart ring, etc. The computing system can further include one or more computing units or nodes on a server, or one or more servers coupled to one another via wired or wireless communication. More details of the computing device are described below in connection with FIG. 5, and more details of the computing system are described below in connection with FIG. 6.

The described subject matters can be implemented using a computer-implemented method; a non-transitory, computer-readable medium storing computer-readable instructions to perform the computer-implemented method; and a computer-implemented system including one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The following detailed description is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as not to obscure one or more described implementations. The present disclosure is not intended to be limited to the described or illustrated implementations, but to be accorded the widest scope consistent with the described principles and features.

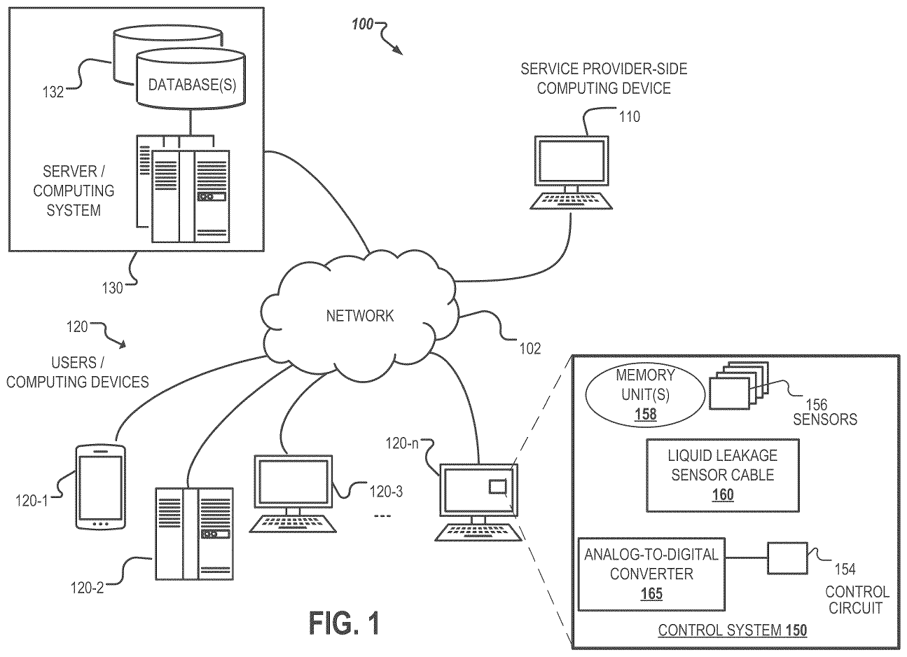

FIG. 1 is a schematic diagram of an example of a system 100 including a computing system 130 (e.g., a server on the service provider side) and one or more computing devices (120-1, 120-2, 120-3, . . . 120-n). At least one computing device, e.g., 120-n, includes a control system 150 for detecting liquid leakage in one or more computing devices (120-1, 120-2, 120-3, . . . 120-n). In some implementations, the control system 150 can detect liquid leakage at two stages, a first, coarse detection stage and a second, refined classification stage.

The computing devices (120-1, 120-2, 120-3, . . . 120-n, which are also referred to generally as computer devices 120 and individually as computer device 120 below) can include one or more computing nodes, one or more user-side servers, or other suitable devices. For simplicity, the description below interchangeably refers to a server 130 as the computing system 130. Similarly, the description below interchangeably refers to one or more computing devices 120 as user devices 120 or user-side servers 120.

In some implementations, the system 100 includes service provider side computing devices 110, user-side computing devices 120 (e.g., one or more mobile device(s) 120-1, one or more server(s) 120-2 (which may perform functions equivalent to those performed by the computing system 130), or one or more user computer(s) 120-3, . . . , 120-n), a server or computing system 130 (which may be cloud-based) on the service provider side, and a network 102. The service provider side computing device 110 can be associated with a corresponding service provider (service company or business entity). The user-side computing devices 120 can be associated with one or more corresponding users. The network 102 can include a large computer network, such as a local area network (LAN), a wide area network (WAN), the Internet, a cellular network, or a combination thereof, connecting any number of mobile computing devices, fixed computing devices, and server systems. The service provider side computing device 110 can be any suitable type of device, system, or server, e.g., a desktop computer, a mobile device, a smart mobile phone, a tablet computing device, a laptop, or a portable communication device.

The system 100 can deploy a Software as a Service (SaaS) model. SaaS is a software distribution model in which a cloud provider (e.g., the server 130) hosts applications and makes them available to end users over the network 102. In this model, an independent software vendor (ISV) (e.g., a service provider) may contract a third-party cloud provider (e.g., Amazon web services (AWS), Microsoft Azure, Google cloud platform (GCP)) to host the application (e.g., an application for battery defect identification). Users can access the software through a web browser without needing to install or maintain it locally on their own computers. Examples of SaaS can include productivity tools like Google Workspace, customer relationship management (CRM) systems like Salesforce, and project management platforms like Asana. With larger companies, such as Microsoft, the cloud provider might also be the software vendor.

The server 130 can include one or more computing devices (e.g., computing nodes, computing units, or computing accelerators) and one or more machine-readable repositories, or databases 132. In some implementations, the server 130 can include one or more server computers in a local or distributed network, each having one or more processing cores. The computing units and accelerators of the server 130 are configured to update or refine one or more control algorithms to be transmitted and deployed on one or more computing devices 120. The system 100 enables users to access a computing system 130 via computing devices 120. For example, a computing device, e.g., 120-n, is configured to receive instructions from the computing system 130 for deploying a control algorithm (or causing the control system 150 to perform operations) for detecting liquid leakage in the computing device 120-n or one or more other computing devices, e.g., 120-1, 120-2, . . . , 120-n-1.

To update or refine one or more control algorithms, the server 130 can deploy machine learning techniques, e.g., by training one or more machine learning models using training data. The training data can include sensor data sensed by one or more sensors, and/or feedback data received from computing devices 120 via network 102. In some implementations, the training data may include historical data related to liquid leakage and, optionally, various actions taken by computing devices according to different liquid leakage conditions. Once the server 130 has trained one or more machine learning models, the server 130 can generate control data (or updated control data on a regular basis) having one or more instructions for detecting liquid leakage from the trained models and automatically (or upon requests from the computing devices 120) provide the control data to the corresponding computing devices 120 via network 102. Once the control data has been deployed in the control system 150 of the corresponding computing device 120, the control system 150 performs liquid-leakage detection operations as prescribed in the control data on a regular basis.

The server 130 can store in the databases 132 historical data and/or information associated with the user and/or the corresponding service provided to the user. The service provider can register an account for the user in the server 130 and enter or update the information of the user and/or the information associated with the service. For example, the service provider side computing device 110 can provide initial control data to be stored in the server 130 (or database(s) 132). The users or computing devices 120 can request to obtain a respective set of control data according to the characteristics of the computing devices 120. Additionally, the database(s) 132 can store sensor data and/or feedback data received from one or more computing devices 120. The service provider side computing device 110 can send instructions to the server 130 to train one or more machine learning models based on received sensor data and/or feedback data stored in the databases 132, and store the trained (or fine-tuned) machine learning models in the database(s) 132. In response to receiving requests from the computing devices 120 for obtaining control data (or updated control data), the service provider side computing device 110 can issue instructions to the server 130 to release the respective control data stored in the databases 132 such that the server 130 can provide the respective control data to the corresponding computing devices 120 via the network 102.

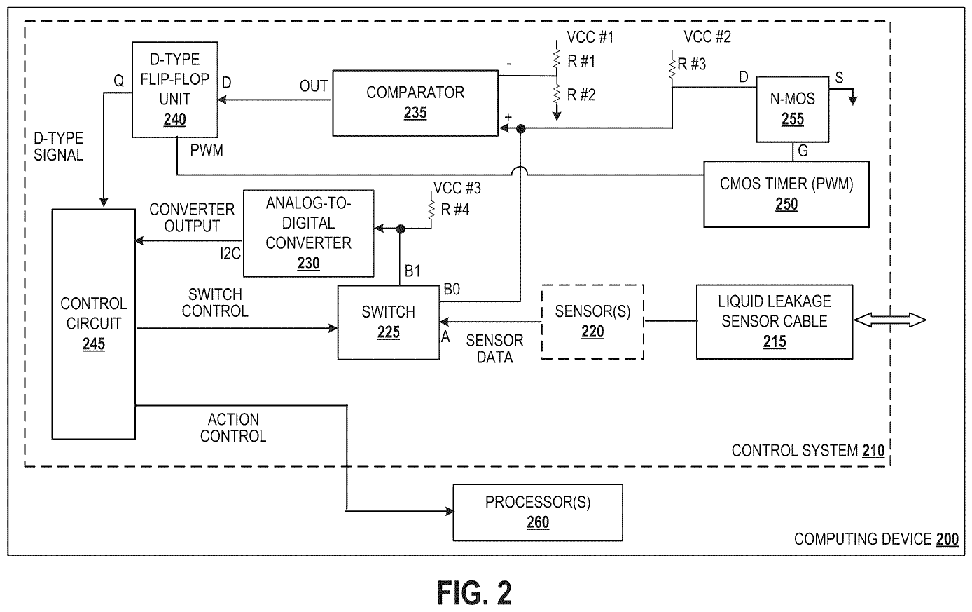

The control data can include logics, threshold values, and/or specific operations performed by components in the control system 150 or the computing device 120-n. For example, the control data can include a particular logic for a control circuit, such that the control circuit is configured to cause a switch (e.g., switch 225 of FIG. 2) to change from a first output path to a second output path according to a first type signal, and reset the switch to connect to the first output path after an event. As another example, the control data can include one or more threshold values representing a level or degree of liquid leakage, e.g., a threshold voltage value (1V, 2V, 5V, etc.), a threshold value using 8-bit or 16-bit data formatting (e.g., 0X3FF, 0X300, 0X201, 0X102, etc.), a threshold current value (e.g., 1.023V, 0.768V, 0.513V, and 0.258, etc., which may correspond to the threshold ADC formatting values above), or other suitable threshold values.

Different leakage categories can be set based on the threshold formatting values and/or the threshold current values. For example, a voltage value above 1.023V (or 0X3FF) may indicate no leakage; a voltage value between 0.768V (or 0X300) and 1.023V (or 0X3FF) may indicate a minor or negligible leakage; a voltage value between 0.513V (or 0X201) and 0.768V (or 0X300) may indicate a mild leakage; a voltage value between 0.256 V (or 0X102) and 0.513V (or 0X201) may indicate a substantial leakage; and a voltage value below 0.258V (or 0X102) may indicate a severe leakage.

Yet as another example, the one or more specific operations or actions to be performed can include various predetermined responsive actions for the computing device. These actions are selected according to the severity or category of the liquid leakage detected. Such actions may include, but are not limited to, logging the event into a system memory, throttling operations of one or more electronic components (e.g., reducing clock speed or power draw), or initiating an immediate shutdown of the computing device. The specific operations can further include defining parameters for circuit operation, such as the duty cycle of a Pulse Width Modulation (PWM) signal generated by a component like a Complementary Metal-Oxide-Semiconductor (CMOS) timer (e.g., CMOS timer 250 of FIG. 2). More details of the logics, threshold values, and/or specific operations are described below in connection with FIG. 2.

Once the computing device 120-n (or the corresponding control system 150) receives the control data from the server 130, the control system 150 can store the control data in one or more memory units 158. As described above, the control data can include logics, threshold values, and/or specific operations performed by components in the control system 150 or the computing device 120-n. In some implementations, the one or more memory units 158 may further store, for example, sensor data and feedback data generated during operation of the computing device 120 for detecting liquid leakage. In addition, the one or more memory units 158 can store information related to historical operations, actions, performance metrics, fault logs, or diagnostic results associated with the control system 150, sensors 156, corresponding electronic components and/or liquid cooling modules assigned to the sensors, or other components of the computing device 120-n. Such historical data may be used to refine control strategies, perform predictive maintenance, or improve reliability over time. The control system 150 may also update its stored data dynamically. For instance, after receiving updated control data from the server 130, the control system 150 can overwrite previous control data with the updated control data at the corresponding memory addresses of one or more memory units 158. In some embodiments, the one or more memory units 158 can additionally maintain versioning records or backup copies of prior control data to enable rollback, error recovery, or comparative performance analysis.

The control system 150 can further include one or more sensors 156 configured to sense or collect sensor data associated with the liquid leakage sensor cable 160. In some implementations, one or more of the sensors 156 may be configured to measure a respective parameter value associated with the liquid leakage sensor cable 160. That said, in some implementations, the control system 150 may not include a sensor that is particularly assigned to the liquid leakage sensor cable 160 for measuring its electrical characteristic values. Instead, other component(s) in the same closed loop (e.g., a comparator 235 or an analog-to-digital converter 230 of FIG. 2) may be configured to imply an electrical characteristic value or a change thereof for the liquid leakage sensor cable 160. These measured parameter values can include, but are not limited to, a voltage value, a resistance value, a current value, or other suitable electrical values whose magnitude changes upon contact with a liquid. The liquid leakage sensor cable 160 itself comprises a flexible element embedded with two or more electrically conductive fibers or deposited with a moisture-sensitive conductive coating, such that the electrical characteristic (e.g., resistance) between the conductors decreases markedly when the cable contacts liquid.

The liquid leakage sensor cable 160 is strategically arranged to optimize detection of liquid leakage within one or more defined leakage-sensing zones of the computing device. Within these zones, the cable 160 is generally located at positions corresponding to the arrangement of pipes, channels, joints, and/or tubes of one or more liquid cooling devices. Since liquid generally tends to flow to the lowest position in the computing device due to gravity, the liquid leakage sensor cable 160 is preferably located at a position lower than the liquid cooling devices in the zone to effectively collect and detect leaked liquid. For example, the liquid leakage sensor cable 160 can be routed to surround the pipes, tubes, or the joints or branch points of the liquid cooling devices. As another example, the liquid leakage sensor cable 160 can be positioned beneath the pipes or tubes, or placed and routed on a plate positioned beneath critical connection points or branches of the liquid cooling devices. In the above-noted scenarios, the one or more sensors 156 can connect to the two ends or terminals of the liquid leakage sensor cable 160 to measure the respective parameter values needed for detection.

The control system 150 further includes an analog-to-digital converter (ADC) 165 configured to process the sensor data (in analog format) received from one or more sensors 156. The ADC 165 is configured to convert the continuous analog sensor data (e.g., a voltage or current value) into a discrete converter output using a digital format. The converter output provides a precise, scaled, quantifiable measure of the analog input and is formatted at a suitable resolution (e.g., 8-bit, 12-bit, or 16-bit), with a higher bit count enabling finer granularity in subsequent leakage classification. The digital converter output is then provided to a control circuit 154 for further processing, specifically for classifying the severity of the liquid leakage into one of a plurality of predetermined categories.

In the context of the two-stage detection scheme, as described above, the ADC 165 is communicatively coupled to the second output path via a switch. The ADC 165 is used only for its refined classification function when the switch is directed to the second output path by the control circuit 154, subsequent to the initial detection of a potential leakage event by the first-stage detection. More details of the ADC 165 and the two-stage detection are described below in connection with FIG. 2.

The control circuit 154 of the control system 150 (or the computing device 120-n) can generally serve as a processor configured to perform various operations for detecting liquid leakage. In some implementations, the control circuit 154 can be a Baseboard Management Controller (BMC) that is coupled to a BMC flash memory device (BMC flash). The BMC is configured to perform operations prescribed in the control data received by the control system 150. For example, the BMC is configured to receive a first type signal indicating a potential liquid leakage at a first, coarse detection stage. The BMC is configured to logically or physically actuate the switch to transition from the first output path to the second output path, initiating a refined classification of liquid leakage at the second, refined classification stage. The BMC is further configured to retrieve the result of the refined classification from the analog-to-digital converter (ADC) 165 (or the ADC 230 of FIG. 2) and, based on this result, select one of a set of predetermined actions to be performed by the computing device 150. After sending control signals to the computing device 150 to execute the selected action (e.g., system shutdown or logging the leakage event), the BMC is further configured to reset the switch to reconnect with the first output path, thereby placing the control system 150 back into the initial state, ready for the next round of coarse detection.

In some implementations, the BMC may incorporate a processor integrated into the motherboard of the computing device 120 and can be configured to perform remote control, management, and monitoring functions, even when the operating system of the computing device is powered off. The BMC flash can store firmware supporting the BMC's functions, such as code for remote power management, hardware monitoring, and system recovery. Additional details of the BMC or control circuit 154 are described below in connection with FIG. 2.

The control system 150 can be integrated into an electrical board (e.g., a motherboard) of the computing device 120-n or integrated on a printed circuit board (PCB) that is configured to be inserted into or coupled to the motherboard of the computing device 120-n. For example, the control circuit 154 may be mounted directly on the motherboard alongside central processing units (CPUs) or memory controllers. In another example, the control circuit 154 may be implemented on a dedicated expansion card (e.g., a PCIe card) that can be inserted into a slot of the motherboard to provide the function of detecting liquid leakage without modifying the base motherboard design. In yet another example, the control circuit 154 may be integrated into a daughterboard carrying multiple controllers and connectors, which can be coupled with the motherboard to detect liquid leakage of various regions of a single computing device or of one or more computing devices.

Additionally, the locations of the components (e.g., sensors 156, liquid leakage sensor cable 160, analog-to-digital converter 165, control circuit 154, etc.) in the control system 150 may vary depending on the needs or requirements of the device, as well as considerations for efficiently detecting liquid leakage in the computing device 120-n.

The control system 150 can be further configured to gather feedback data in response to the initial detection of liquid leakage, as well as subsequent to the computing device 120-n performing the selected action corresponding to the classified liquid leakage. This feedback data monitors the status of the electronic components, the control circuit 154, and the computing device 150 itself. For example, the feedback data can include data monitoring the functioning of the electronic components after the control system 150 determines a minor liquid leakage and maintains the current operations of those electronic components in the computing device. As another example, the feedback data can include post-action sensor data to confirm that a high-severity action, such as a complete system shutdown, successfully arrested the leakage or prevented further damage. In yet another example, feedback data can relate to the monitored thermal profile and electrical stability of critical components after a specified action (e.g., throttling component speed) to ensure the corrective measure effectively mitigates the risk posed by leakage without causing new operational instability. As described above, the collected feedback data can be transmitted to server 130, where it is used to optimize the control algorithm for future detection cycles, including refining one or more machine learning models. Thus, a system implementing the described techniques can periodically update control data and transmit it to computing devices upon request, thereby improving the accuracy of leakage classification and the efficacy of subsequent responsive actions.

FIG. 2 is a schematic diagram of an example of a computing device 200 having a control system 210. Computing device 200 described herein can be the same as, or similar to, the computing device 120-1, 120-2, . . . or 120-n of FIG. 1. Control system 210 described herein can be the same as, or similar to, the control system 150 of FIG. 1.

As shown in FIG. 2, the computing device 200 is shown to include a control system 210 configured to efficiently detect and classify liquid leakage using a two-stage detection mechanism. Liquid leakage can originate from various sources. For example, liquid in liquid-cooling devices, such as coolant, might leak through pipes or conduits, joints, and connectors between pipes or conduits, or other locations within the liquid-cooling devices. As another example, liquid can condense from the ambient air and land on electronic components and/or circuits. Yet another example of a leakage cause is the failure of a pump or reservoir seal. Furthermore, the improper assembly of a cold plate or manifold can introduce leakage. Since the severity (degree) of the leakage varies significantly across different causes, it is advantageous for the control system 210 to classify the leakage conditions and tailor a corresponding appropriate action for the computing device 200 to mitigate the leakage issue.

More specifically, the two-stage detection mechanism, deployed by the control system 210, comprises a first, coarse detection stage and a second, refined classification stage. In the first, coarse detection stage, the control system 210 is configured to quickly detect the potential presence of liquid leakage. Upon this initial detection, the control system 210 is caused to initiate the second, refined classification stage. In the second stage, the control system 210 is configured to classify a category of the liquid leakage from among a plurality of predetermined categories, and subsequently determine and execute a proper action in response to the classified category. More details of the two-stage detection mechanism are described immediately below.

The control system 210 may include one or more sensors 220 and one or more target elements whose characteristics (or derived characteristics) are sensed by the sensors. For example, as shown in FIG. 2 and within the liquid detection context, the one or more target elements can include a liquid-sensitive cable (e.g., the liquid leakage sensor cable 215) that exhibits a significant change in an electrical characteristic, such as resistance, when in contact with liquid. In this scenario, the one or more sensors 220 may be accordingly configured to sense the resistance value change in the cable. However, in some implementations, the control system 210 need not explicitly include one or more sensors configured to measure electrical characteristics of the liquid leakage sensor cable 215. Instead, in some implementations, electrical characteristic values (or changes thereof) of the liquid leakage sensor cable 215 can be derived from sensor data measured for components other than the liquid leakage sensor cable 215. In some other implementations, one or more different components in the same closed circuit (e.g., the comparator 235 in the A-B0 route or the analog-to-digital converter 230 in the A-B1 route of FIG. 2) may imply electrical characteristic values or changes thereof for the liquid leakage sensor cable 215. For example, when the liquid leakage sensor cable 215 is dry (or does not contact any liquid), it may have a pretty large resistance value such that the circuit along the A-B0 route appears to be an open circuit. Once the liquid leakage sensor cable 215 contacts liquid, its resistance drops sharply, causing the circuit to transition from an open to a closed state. That change in the resistance value, the voltage value, or the current value of the liquid leakage sensor cable 215 may be captured by other components in the A-B0 route (e.g., the comparator 235) of the circuit. Also, note that the sensor(s) 220 are illustrated in dashed lines in FIG. 2, which clearly indicates that sensors(s) 220 may be omitted in some implementations, as described above.

In some implementations, the target elements can include a liquid-sensitive cable that changes drastically in other characteristics when in contact with liquid. For example, the target element could be an optical fiber whose light transmission characteristic (e.g., attenuation) changes when the fiber contacts liquid. As shown in FIG. 2, the control system 210 includes a liquid leakage sensor cable 215, which typically reduces its electrical resistance when in contact with liquid. The control system 210 further includes one or more sensors 220 communicatively coupled to the liquid leakage sensor cable 215 for detecting a change in the resistance value (or a derived parameter, such as voltage or current).

To optimize the robustness and sensitivity to liquid, the liquid leakage sensor cable 215 is strategically located or arranged at positions that are most likely to observe liquid leakage. These locations can include, but are not limited to, the direct path of pipes and conduits of liquid cooling devices, and critical stress points such as joints and connectors of those pipes and conduits. The cable 215 can be located in one or more leakage-sensing zones of the computing device 200, where those zones are positioned to conveniently collect leaked liquid. For example, those zones can be located at a relatively lower elevation in the computing device, since liquid tends to flow downward due to gravity. The liquid leakage sensor cable 215 can either be arranged to surround the pipes, conduits, or joints/connectors thereof, of the liquid cooling devices, or be arranged on a fluid-collecting plate in the leakage sensing zones.

Although FIG. 2 shows that the control system 210 includes a liquid leakage sensor cable 215 as an example target element, other types of target elements can be used according to different requirements or conditions for liquid leakage detection. For example, the target elements could include discrete liquid spot sensors (e.g., capacitive or resistive pads) positioned at high-risk locations. Similarly, although sensors 220 are described as detecting a change in resistance in the liquid leakage sensor cable 215, other suitable sensors can be used in accordance with the chosen target element. For example, if an optical fiber is used as the target element, sensors 220 would include a light source and a photodetector to measure physical parameters related to light transmission.

The sensor(s) 220 are configured to transmit the collected sensor data for the liquid leakage sensor cable 215 to the switch 225. The collected sensor data can be analog data. At the beginning of each detection cycle, the switch 225 is connected to the first output path (hereinafter referred to as the A-B0 path), thereby placing the control system 210 in the first, coarse detection stage. In this configuration, the sensor data is routed via switch 225 to the non-inverting input end (“+”) of the comparator 235. The liquid leakage sensor cable 215 is configured in a voltage divider circuit along the A-B0 path with a resistor, hereinafter resistor R #3, where the top end of R #3 is coupled to an external positive supply voltage, VCC #2. The voltage at the non-inverting input end (“+”) of comparator 235 is therefore the voltage across the liquid leakage sensor cable 215 and is responsive to the change of resistance value in the liquid leakage sensor cable 215.

The inverting input end (“−”) of the comparator 235 is coupled to a predetermined reference voltage Vref established by a separate voltage divider. Specifically, the inverting input end (“−”) is connected between two resistors, resistor R #1 and resistor R #2. The top end of R #1 is connected to an external positive supply voltage, VCC #1, and the bottom end of R #2 is connected to the ground level (0V). Note that VCC #1 and VCC #2 are not necessarily set to the same voltage value. The design and values of the VCCs, the resistors (R #1, R #2, R #3), and the liquid leakage sensor cable 215 are selected such that when the liquid leakage sensor cable 215 is dry (i.e., at its maximum resistance), the voltage at the non-inverting input end (“+”) is equal to or slightly above the reference voltage Vref at the inverting input end (“−”).

Thus, when the liquid leakage sensor cable 215 is dry, the voltage at the non-inverting input end (“+”) is greater than or equal to the voltage at the inverting input end (“−”). In this “no leak” condition, the comparator 235 generates a high output signal. This high signal is captured and held by the D-type flip-flop unit 240 for a sampling cycle. Conversely, when the liquid leakage sensor cable 215 is in contact with liquid, its resistance value decreases significantly (since liquid provides a parallel conductive path). This resistance drop causes the voltage distributed to the liquid leakage sensor cable 215 (and consequently the voltage at the non-inverting input end (“+”)) to decrease and fall below the reference voltage Vref at the inverting input end (“−”). This voltage imbalance causes comparator 235 to generate a low output signal, indicating a potential leakage event, which is also sent to D-type flip-flop unit 240 for downstream processing.

It should be noted that the design parameters, including the external voltages (VCC #1 or VCC #2), the resistor values (R #1, R #2, and R #3), and the resultant voltage values set at the non-inverting and inverting input ends, can be optimized according to different liquid detection requirements. For instance, the external voltages can be configured as negative voltages in alternative embodiments. Furthermore, the voltage at the inverting input (“−”) is a predetermined threshold, adjustable by varying R #1 and R #2 to set the required sensitivity of the first, coarse detection stage.

The control system 210 further includes an N-type Metal-Oxide-Semiconductor (N-MOS) unit 255 coupled to the first output path (A-B0 path). The N-MOS 255 functions as a switch or gate, intermittently enabling power flow to the liquid leakage sensor cable 215. Since power is provided intermittently rather than continuously, the control system 210 further reduces power consumption, corrosion, and component wear, particularly for the liquid leakage sensor cable 215. More specifically, the N-MOS 255 has a Source (“S”) end and a Drain (“D”) end. In this configuration, the Drain end (“D”) is coupled to the non-inverting input end (“+”) of the comparator 235. The N-MOS unit 255 further has a Gate (“G”) end coupled to the Complementary Metal-Oxide-Semiconductor (CMOS) Timer 250. The Gate end (“G”) receives a Pulse Width Modulation (PWM) signal from the CMOS Timer 250 during a PWM duty cycle or detection cycle. The N-MOX unit 255 acts as a switch controlled by the PWM signal, connecting the external voltage (VCC #2) to the liquid leakage sensor cable 215 only when the N-MOS unit 255 receives the PWM signal during brief sampling intervals determined by the PWM duty cycle. For example, the PWM duty cycle can be 20%, 30%, 50%, 70%, or other suitable values.

As shown in FIG. 2, the CMOS Timer 250 is further connected to a clock or power gate of the D-type flip-flop unit 240 and periodically provides a PWM signal to trigger the operation. The D-type flip-flop unit 240 is an event-controlled storage element configured to capture and maintain a signal for a particular time period in observation of a clocking event. Specifically, the D-type flip-flop unit 240 is used by the control system 210 to sample and hold the output of the comparator 235 synchronously with the intermittent powering of the sensor, since both the D-type flip-flop unit 240 and the N-MOS 255 are powered by the CMOS Tiner 250. The D-type flip-flop unit 240 further includes a data input end (e.g., “D” gate shown in FIG. 2) configured to receive the output signal (e.g., a high or low output signal) directly from the comparator 235. The PWM signal from the CMOS Timer 250 is received by the clock input end of the D-type flip-flop unit 240, causing the flip-flop to capture the current state of the “D” gate only when the clock signal transitions (e.g., on the rising edge of the PWM pulse, which coincides with the time the liquid leakage sensor cable 215 is powered).

Based on the received input signal from the comparator 235, the D-type flip-flop unit 240 is configured to generate and stabilize a D-type signal from the output end (e.g., the “Q” gate shown in FIG. 2) and provide it as an input to the control circuit 245. The D-type signal is generally binary, representing the result of the coarse detection stage. For example, the D-type signal can be a first signal (e.g., a logic “LOW”) indicating potential liquid leakage when the comparator 235 outputs a low signal when the sensor voltage drops below a threshold value. As another example, the D-type signal can be a second signal (e.g., a logic “HIGH”), different from the first signal, indicating no liquid leakage when the comparator 235 outputs a high signal. This sampled output is then provided to the control circuit 245 for further processing.

The control circuit 245 is configured to process the D-type signal received from the D-type flip-flop unit 240 to determine whether to transition the control system 210 from the first, coarse detection stage to the second, refined classification stage. Specifically, the control circuit 245 determines whether the D-type signal represents a detection of potential liquid leakage (e.g., the first signal, logic “LOW”). In response to determining that the D-type signal indicates potential liquid leakage, the control circuit 245 generates a switch control signal and issues it to the switch 225, instructing the switch 225 to change its connectivity from the first output path (A-B0 path) to the second output path (A-B1 path). This transition initiates the second, refined classification stage. Conversely, if the control circuit 245 determines that the D-type signal represents no liquid leakage (e.g., the second signal, logic “HIGH”), the control circuit 245 generates a switch control signal that causes the switch 225 to maintain its connection with the A-B0 path, thereby continuing the low-power coarse detection stage.

The control circuit 245 can be implemented by a Baseboard Management Controller (BMC) or equivalent system management hardware. A BMC is a specialized, autonomous microcontroller configured to monitor the physical state of the computing device 200, including temperature, voltage, fan status, and operation of device components, or other suitable parameters or characteristics associated with the computing device 200. The BMC is generally independent of the main CPU in the computing device 200. In liquid leakage detection, the BMC 260 serves as the primary processing unit for the control circuit 245. The BMC 260 executes core logic by receiving signals along different paths at different detection stages and determining whether to transition from the first, coarse detection stage to the second, refined classification stage.

Once the switch 225 transitions the connectivity to the second output path (A-B1 path), the control system 210 initiates the operations of the second, refined classification stage. In the A-B1 path, the switch 225 connects the sensor circuit directly to the input end of the analog-to-digital converter (ADC) 230. Similar to the first output path, the liquid leakage sensor cable 215 is configured in a voltage divider circuit with a series resistor, hereinafter resistor R #4, coupled to an external positive supply voltage, VCC #3. The voltage presented at the input of the ADC 230 is a precise analog representation of the sensor cable's resistance value, which is inversely proportional to the amount of liquid that the liquid leakage sensor cable 215 is exposed to.

The ADC 230 converts an analog voltage or current into a digital output, represented in a data format with a predetermined bit size, such as 8-bit, 10-bit, 12-bit, 16-bit, or higher. This conversion process effectively maps the continuous range of analog sensor data into a large number of discrete categories of leakage conditions or degrees (much more refined than a binary classification used by a conventional detection system). The total number of categories, N, is directly associated with the resolution of the digital data format, e.g., as an exponential function of base 2 with index equal to the bit count. For example, a 10-bit ADC 230 can classify the analog sensor data into 1024 distinct categories, providing a significantly finer granularity than the binary output of the first stage.

This high resolution allows the control system to distinguish between various leakage scenarios. For instance, in a 10-bit system, a high voltage reading, such as 1.023V, could be mapped to a high digital value (e.g., 0X3FF), corresponding to a minimum-to-no liquid leakage condition (or a minor false alarm). A mid-range voltage, such as 0.768V, could be mapped to an intermediate digital value (e.g., 0X300). corresponding to a first level of liquid leakage. This condition might be classified as non-critical, such as water condensed from the air. A lower voltage, such as 0.513V, could be mapped to another digital value (e.g., 0X201), corresponding to a second level of liquid leakage, which could be classified as intermittent, manageable leakage from a liquid cooling device. Finally, a very low voltage, such as 0.258V, could be mapped to a low digital value (e.g., 0X102), corresponding to a third level of liquid leakage, indicating a continuous and substantial amount of liquid leakage that requires immediate response.

The ADC 230 generates a converter output that includes the converted digital value in the specified data format and provides it to the control circuit 245 for further processing, typically via a standard serial interface such as an Inter-Integrated Circuit (I2C) bus. The control circuit 245 then uses this classified category to select the appropriate responsive action.

Upon receiving the refined converter output from the ADC 230, the control circuit 245—which may be implemented via the BMC—is configured to select a corresponding responsive action from a set of predefined actions. This selection process maps the received digital value to a specific leakage condition category, each associated with a defined level of operational risk. For example, if the control circuit 245 receives a high digital value, such as 0X3FF, it determines that a minimum-to-no liquid leakage condition is present. Under this condition, the control circuit 245 determines that no intervention is required and generates an action control signal that causes the processor(s) 260 to maintain current operations.

As the detected leakage severity increases, indicated by progressively lower digital values, the control circuit 245 initiates more aggressive mitigation strategies. When the control circuit 245 receives a mid-range digital value such as 0X300, it classifies the event as a first level of liquid leakage. In this scenario, the control circuit 245 determines that the processor(s) 260 should log the event within a system management log while instructing the computing device 200 to continue operating without interruption. If a lower digital value, such as 0X201, is received, the control circuit 245 classifies the event as a second level of liquid leakage. This classification causes the control circuit 245 to instruct the processor(s) 260 to log the event and generate a system alarm or notification to an administrator, while still allowing the computing device 200 to continue its current operational state.

In the event of a critical leak, characterized by a low digital value such as 0X102, the control circuit 245 identifies a third level of liquid leakage, indicating a substantial, continuous leak. To mitigate the high risk of catastrophic short-circuit damage to internal electronic components, the control circuit 245 immediately generates an action control signal to instruct the processor(s) 260 or an associated power distribution unit to initiate an emergency shutdown of the computing device 200. After executing any of these predetermined actions according to the received digital value, the control circuit 245 completes the two-stage detection cycle by generating a final switch control signal. This signal causes the switch 225 to reset its connectivity to the first output path (A-B0 path), effectively returning the control system 210 to the first, coarse detection stage for continuous, low-power monitoring in preparation for the next detection event.

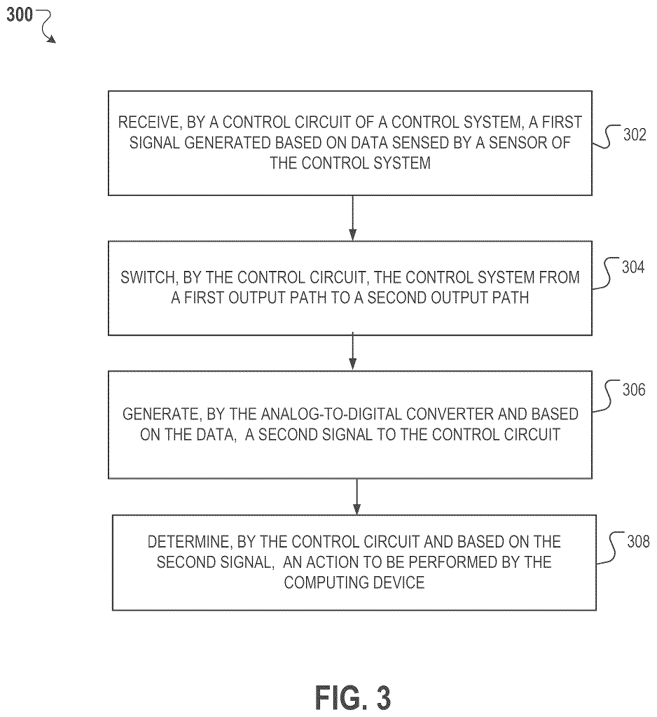

FIG. 3 is a flow diagram of an example process 300 of detecting liquid leakage using the control system of FIG. 2. For convenience, the process 300 is described as being performed by a computing device with one or more control processors located in one or more locations, and the computing device is communicatively coupled with a computing system to transmit data back and forth. For example, a system, e.g., the control system 150 including the computing devices 120-n as shown in FIG. 1 (or the control system 210 of FIG. 2), when appropriately programmed, can perform the process 300. For simplicity, the operations in process 300 are described below with respect to a computing device communicatively coupled to a computing system.

As described above, the control system implements a two-stage detection scheme, where the first stage performs coarse detection of potential liquid leakage and the second stage refines the classification of the liquid leakage condition when the first stage indicates a potential leak. More specifically, when the control system performs operations in the first stage, the control circuit of the control system receives a first signal generated based on data sensed by a sensor of the control system. (302). The first signal generally refers to an output generated by an event-controller of the control system. The event-controller is configured to maintain the first signal for a particular time period. As described above, the event-controller can include a D-type flip-flop unit, which is periodically powered by a PWM signal issued by a CMOS Timer. The time period for holding the first signal can be determined based on the PWM duty cycle set by the CMOS Timer. The first signal can be a D-type signal, a binary signal indicating whether there is a potential liquid leakage in the computing device.

The sensor data is acquired by one or more sensors 156 configured to monitor one or more target units within the computing device. These target elements may be implemented in various forms, such as a sensing cable comprising specialized conductive fibers or moisture-sensitive coatings that exhibit a substantial change in one or more physical or electrical characteristics upon contact with liquid. For example, as previously described, the target element may be a liquid leakage sensor cable 160 disposed within the computing device and strategically arranged within leakage sensing zones proximate to high-risk locations, such as the pipes, conduits, manifolds, or the joints and connectors of a liquid cooling system.

Depending on the nature of the target element, the sensors 156 may include resistance sensors, current sensors, voltage sensors, optical sensors, or other suitable sensing transducers. Accordingly, the sensor data represents a measured parameter—such as resistance, current, voltage, or optical attenuation—associated with the state of the liquid leakage sensor cable. This parameter value serves as the primary metric for the control system to determine the presence and severity of liquid ingress.

In response to receiving the first signal indicating that a liquid leakage is detected in the computing device, the control circuit switches the control system from a first output path to a second output path. (304). As described above, the switch is initially connected to a first output path, which connects a comparator and the D-type flip-flop unit. The comparator is configured to determine whether the analog voltage divided by the sensor cable and sensed by the sensor(s) is equal to or less than a predetermined threshold value. When the analog voltage is below the predetermined threshold, the comparator generates a low-level signal that, when received by the D-type flip-flop unit, causes it to generate the first signal indicating liquid leakage. Upon receiving the first signal, the control circuit completes the first-stage coarse detection and initiates the second-stage refined classification by connecting to the second output path. However, if the comparator determines that the analog voltage is equal to or even above the threshold value, the comparator generates a high level value that, once received by the D-type flip-flop unit, causes the D-type flip-flop unit to generate a signal to the control circuit that represents no detection of liquid leakage in the computing device. In response, the control circuit issues a switch signal to maintain the current connectivity to the first output path, and thus maintains the operations at the first, coarse detection stage.

An analog-to-digital converter (ADC) is connected in the second output path and configured to generate a second signal based on the data to the control circuit. (306). In particular, the ADC can map the analog data into digital data in a specified format. As described above, the ADC converts an analog voltage into a discrete 10-bit integer. The maximum representable value or range of the format can correspond to the total number of categories of liquid leakage conditions. The ADC can generate a second signal (or a converter output as described above) to the control circuit for further processing.

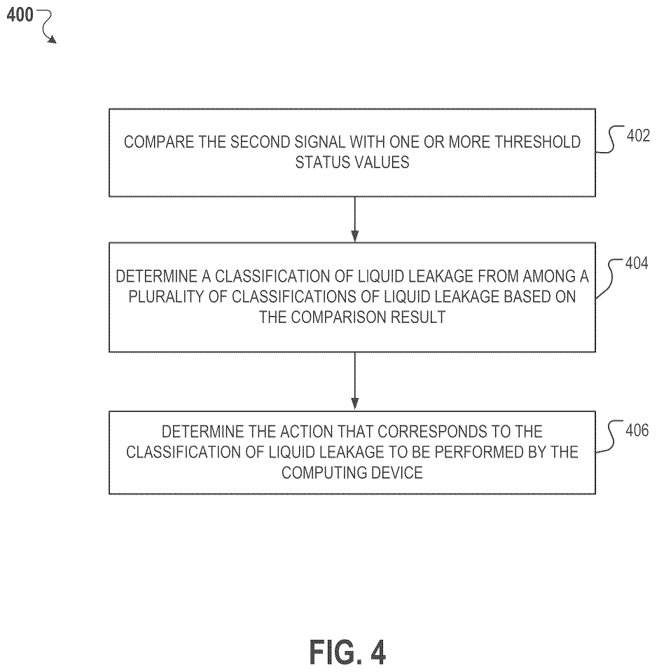

Upon receiving the digital data, the control circuit is configured to determine an action to be performed by the computing device. (308). To determine this action, the control circuit first executes a categorization logic that maps the high-resolution digital data to a specific category of liquid leakage condition. This mapping process identifies the severity and nature of the detected liquid, distinguishing between benign moisture and critical cooling system failures. Once the category is identified, the control circuit selects a corresponding predetermined action from a pre-determined set of actions stored in the memory. Further operational details of determining an action to be performed by the system are described below in connection with FIG. 4.

The predetermined actions are designed to be proportional to the identified risk level and may include maintaining the current operational state of the computing device, implementing performance throttling, or initiating an emergency system-wide shutdown. In some implementations, the predetermined actions can include recording telemetry and event metadata—such as the raw digital data values, the state of the first and second signals, the timestamp of the event, and the specific action taken—into a persistent log file for subsequent forensic analysis. Yet in some other situations, the predetermined actions can include generating a warning signal, which may comprise triggering a visual indicator on the device chassis, issuing an interrupt to the operating system, displaying a notification on a display to an administrator, transmitting an alert via a network interface to a remote management console, or other suitable notifications.

Subsequent to execution of the determined action or transmission of the corresponding control signals to the processor(s) in the computing device, the control circuit is configured to reset the detection stage. This involves generating a switch control signal that transitions the control system from the second output path (the refined classification stage) back to the first output path (the coarse detection stage). This reset operation enables the control system to resume the continuous coarse-detection stage for potential leakage events while minimizing power consumption.

FIG. 4 is a flow diagram of an example process 400 of processing a converter output to determine an action to be performed by the computing device. For convenience, the process 400 is described as being performed by a control circuit of the computing device. For example, the control circuit 245 of FIG. 2, when appropriately programmed, can perform the process 400. For simplicity, the operations in process 400 are described below with respect to a control circuit in a computing device.

To determine the action, the control circuit first compares the second signal with one or more threshold status values. (402). The second signal generally refers to the converter output from the ADC. The one or more threshold status values are stored in the control system's firmware and represent the boundary conditions between different physical states of the sensing element. For example, the control circuit may utilize a high threshold value to distinguish between dry conditions and ambient humidity. As another example, the control circuit can use a series of lower threshold values to distinguish between a slow coolant drip and a catastrophic pipe rupture. By comparing the digitized voltage level against these multi-level benchmarks, the control circuit can precisely evaluate the magnitude of the resistance drop in the sensor cable. As described above, the one or more threshold statue values can relate to one or more ADC values mapped from analog voltage values, e.g., 0X3FF, 0X300, 0X201, 0X120, or other suitable values.

The control circuit determines the classification of liquid leakage from among a plurality of classifications based on the comparison result. (404). Each of the plurality of classifications of liquid leakage may correspond to one of the threshold status values. As described above, in one implementation, a digital value above a maximum threshold value can be classified as a “minimum to no leakage” category (or a false alarm condition, even if the control circuit determines a leakage in the first coarse detection stage), and a digital value below the maximum threshold value and above a minor leakage threshold value can represent a first level leakage category, representing minor leakage caused by, e.g., condensed water from the air. As another example, a digital value falling between the minor leak threshold value and a major leak threshold value can be classified as the second level leakage category that represents an intermittent, moderate leak. Yet as another example, a digital value falling below the major leak threshold value can represent a substantial leakage category. As described above, the threshold value can be associated with a divided voltage assigned to the target element in the circuit. This refined tier classification mechanism allows the system to move beyond binary “on/off” detection and instead categorize the event based on the actual volume or liquid leakage rate sensed at the target element.

The control circuit determines the action that corresponds to the classification of liquid leakage to be performed by the computing device. (406) This ensures that the system response is tailored to the severity of the leakage threat. For instance, a first-level leakage category classification (e.g., water condensation) may trigger an action to increase local fan speeds to facilitate evaporation, while maintaining the operations of other electronic components in the computing device and logging the detection of the event and actions taken by the computing device in response to the detection of the event in a log file. However, a third-level leakage category that represents a continuous leakage stream would trigger an immediate command to the computing device's power distribution unit to shut off the power.

In some implementations, the control system is further configured to communicate with a remote computing system, such as a management server, to enable dynamic updates and optimization of control strategies. Through this communicative coupling (e.g., via a network interface or a dedicated management bus), the server can push updated configurations to the control circuit, including adjusted ADC mapping tables, revised data formats, or redefined leakage categories. Furthermore, the server may analyze historical feedback data collected from the computing devices to refine the threshold status values or the associated action logic. This allows the system to adapt to varying environmental conditions or hardware updates, ensuring that the leakage detection algorithms remain optimized throughout the computing device's lifecycle.

FIG. 5 is a block diagram illustrating an example architecture of a computing device 500 used to provide computational functionalities associated with described algorithms, methods, functions, processes, flows, and procedures. Other architectures are possible, including architectures with more or fewer components. The computing device can be implemented as the computing device 100 of FIG. 1. The computing device 500 includes processor 504, memory 506, storage component 508, input interface 510, output interface 512, communication interface 514, and bus 502.

Bus 502 includes a component that permits communication among the components of the computing device 500. In some embodiments, processor 504 is implemented in hardware, software, or a combination of hardware and software. In some examples, processor 504 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 506 includes random access memory (RAM), read-only memory (ROM), and/or another type of dynamic and/or static storage device (e.g., flash memory, magnetic memory, optical memory, and/or the like) that stores data and/or instructions for use by processor 504.

Storage component 508 stores data and/or software related to the operation and use of the computing device 500. In some examples, storage component 508 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 510 includes a component that permits the computing device 500 to receive information, such as via user input (e.g., a touchscreen display, a keyboard, a keypad, a mouse, a button, a switch, a microphone, a camera, and/or the like). Additionally or alternatively, in some embodiments, input interface 510 includes a sensor that senses information (e.g., a global positioning system (GPS) receiver, an accelerometer, a gyroscope, an actuator, and/or the like). Output interface 512 includes a component that provides output information from the computing device 500 (e.g., a display, a speaker, one or more light-emitting diodes (LEDs), and/or the like).

In some embodiments, communication interface 514 includes a transceiver-like component (e.g., a transceiver, a separate receiver and transmitter, and/or the like) that permits the computing device 500 to communicate with other devices via a wired connection, a wireless connection, or a combination of wired and wireless connections. In some examples, communication interface 514 permits the computing device 500 to receive information from another device and/or provide information to another device. In some examples, communication interface 514 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 500 performs one or more processes described herein. The computing device 500 performs these processes based on processor 504 executing software instructions stored by a computer-readable medium, such as memory 506 and/or storage component 508. A computer-readable medium (e.g., a non-transitory computer-readable medium) is defined herein as a non-transitory memory device. A non-transitory memory device includes memory space located inside a single physical storage device or memory space spread across multiple physical storage devices.

In some embodiments, software instructions are read into memory 506 and/or storage component 508 from another computer-readable medium or another device via communication interface 514. When executed, software instructions stored in memory 506 and/or storage component 508 cause processor 504 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 506 and/or storage component 508 includes data storage or at least one data structure (e.g., a database and/or the like). The computing device 500 is capable of receiving information from, storing information in, communicating information to, or searching information stored in the data storage or at least one data structure in memory 506 or storage component 508. In some examples, the information includes network data, input data, output data, or any combination thereof.

In some embodiments, the computing device 500 is configured to execute software instructions that are either stored in memory 506 and/or in the memory of another device (e.g., another device that is the same as or similar to the computing device 500). As used herein, the term “module” refers to at least one instruction stored in memory 506 and/or in the memory of another device that, when executed by processor 504 and/or by a processor of another device (e.g., another device that is the same as or similar to the computing device 500) cause the computing device 500 (e.g., at least one component of the computing device 500) to perform one or more processes described herein. In some embodiments, a module is implemented in software, firmware, hardware, and/or the like.

The number and arrangement of components illustrated in FIG. 5 are provided as an example. In some embodiments, the computing device 500 can include additional components, fewer components, different components, or differently arranged components than those illustrated in FIG. 5. Additionally or alternatively, a set of components (e.g., one or more components) of the computing device 500 can perform one or more functions described as being performed by another component or another set of components of the computing device 500.

FIG. 6 illustrates an example architecture 600 of a computing system used to provide computational functionalities associated with described algorithms, methods, functions, processes, flows, and procedures. The computing system can include one or more computing devices, such as the computing device 100 of FIG. 1 or the computing device 200 of FIG. 2. Other architectures are possible, including architectures with more or fewer components.

In some implementations, architecture 600 includes one or more processor(s) 602 (e.g., dual-core Intel® Xeon® Processors), one or more network interface(s) 606, one or more storage device(s) 604 (e.g., hard disk, optical disk, flash memory), and one or more computer-readable medium(s) 608 (e.g., hard disk, optical disk, flash memory, etc.). These components can exchange communications and data over one or more communication channel(s) 610 (e.g., buses), which can utilize various hardware and software for facilitating the transfer of data and control signals between components.

The term “computer-readable medium” refers to any medium that participates in providing instructions to the processor(s) 602 for execution, including, without limitation, non-volatile media (e.g., optical or magnetic disks), volatile media (e.g., memory), and transmission media. Transmission media includes, without limitation, coaxial cables, copper wire, and fiber optics.

Computer-readable medium(s) 608 can further include instructions 612 for an operating system (e.g., Mac OS® server, Windows® NT server, Linux Server), instructions 614 for network communications module, data processing instructions 616, and interface instructions 618.

Operating systems can be multi-user, multiprocessing, multitasking, multithreading, real time, etc. Operating system performs basic tasks, including but not limited to: recognizing input from and providing output to devices 602, 604, 606 and 608; keeping track and managing files and directories on computer-readable medium(s) 608 (e.g., memory or a storage device); controlling peripheral devices; and managing traffic on the one or more communication channel(s) 610. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 616 include server-side or backend software for implementing the server-side operations. Interface instructions 618 includes software for implementing a web server and/or portal for sending and receiving data to and from user side computing devices and service provider side computing devices.

Architecture 600 can be implemented by a cloud computing system and can be included in any computer device, including one or more server computers in a local or distributed network each having one or more processing cores. Architecture 600 can be implemented in a parallel processing or peer-to-peer infrastructure or on a single device with one or more processors. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While t he requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or, A and B.” As used herein, the term “and/or” as used herein refers to and encompasses any and all possible combinations of one or more of the associated listed terms. For example, the term “A and/or B” means that either option A, option B, or both options A and B are possible, where A and B may be singular or plural.

As used herein, the term “about” or “approximately” can allow for a degree of variability in a value or range, for example, within 10%, within 5%, or within 1% of a stated value or of a stated limit of a range. As used herein, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

In addition, the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The breadth and scope of the present disclosure should not be limited by any of the above-described exemplary implementations, but should be defined only in accordance with the following claims and their equivalents.

What is claimed is:

1. A method, comprising:
receiving, by a control circuit of a control system, a first signal generated based on data associated with a sensing element in the control system, wherein the first signal indicates that liquid leakage is detected in a computing device;
switching, by the control circuit, the control system from a first output path to a second output path, wherein the second output path connects to an analog-to-digital converter of the control system;
generating, by the analog-to-digital converter and based on the data, a second signal to the control circuit; and
determining, by the control circuit and based on the second signal, an action to be performed by the computing device.

2. The method of claim 1, comprising:
causing the computing device to perform the action, wherein the action comprises one or more of (i) maintaining current operations of the computing device or shutting down the computing device, (ii) storing information related to the data, the first signal, the second signal, or the action into a log file, and (iii) generating a warning signal.

3. The method of claim 1, wherein the first signal is generated by an event-controller of the control system, the event-controller being configured to maintain the first signal for a time period, wherein the method further comprises:
in response to determining that a value of the data is below a threshold value, generating the first signal by the event-controller.

4. The method of claim 1, wherein the first signal is generated by an event-controller of the control system, the event-controller being configured to maintain the first signal for a time period, wherein the method further comprises:
in response to determining that a value of the data is equal to or above a threshold value, generating, by the event-controller, a third signal that represents no detection of liquid leakage in the computing device.

5. The method of claim 1, wherein the sensing element comprises a liquid leakage sensor cable, and wherein the data comprises a resistance value of the liquid leakage sensor cable enclosed by a housing of the computing device.

6. The method of claim 1, further comprising:
after determining the action to be performed by the computing device, switching the control system from connecting to the second output path back to connecting to the first output path.

7. The method of claim 1, wherein determining, by the control circuit and based on the second signal, the action to be performed by the computing device comprises:
generating a comparison result by comparing the second signal with one or more threshold status values;
determining a classification of liquid leakage from among a plurality of classifications of liquid leakage based on the comparison result, wherein each of the plurality of classifications of liquid leakage corresponds to one of the one or more threshold status values; and
determining the action that corresponds to the classification of liquid leakage to be performed by the computing device.

8. A system comprising one or more computers and one or more storage devices storing instructions that, when executed by one or more computers, cause the one or more computers to perform respective operations, the respective operations comprising:
receiving, by a control circuit of a control system, a first signal generated based on data associated with a sensing element in the control system, wherein the first signal indicates liquid leakage is detected in a computing device;
switching, by the control circuit, the control system from a first output path to a second output path, wherein the second output path connects to an analog-to-digital converter of the control system;
generating, by the analog-to-digital converter and based on the data, a second signal to the control circuit; and
determining, by the control circuit and based on the second signal, an action to be performed by the computing device.

9. The system of claim 8, wherein the respective operations comprise:
causing the computing device to perform the action, wherein the action comprises one or more of (i) maintaining current operations of the computing device or shutting down the computing device, (ii) storing information related to the data, the first signal, the second signal, or the action into a log file, and (iii) generating a warning signal.

10. The system of claim 8, wherein the first signal is generated by an event-controller of the control system, the event-controller being configured to maintain the first signal for a time period, wherein the respective operations further comprise:
in response to determining that a value of the data is below a threshold value, generating the first signal by the event-controller.

11. The system of claim 8, wherein the first signal is generated by an event-controller of the control system, the event-controller being configured to maintain the first signal for a time period, wherein the respective operations further comprise:
in response to determining that a value of the data is equal to or above a threshold value, generating, by the event-controller, a third signal that represents no detection of liquid leakage in the computing device.

12. The system of claim 8, wherein the sensing element comprises a liquid leakage sensor cable, and wherein the data comprises a resistance value of the liquid leakage sensor cable enclosed by a housing of the computing device.

13. The system of claim 8, wherein the respective operations comprise:
after determining the action to be performed by the computing device, switching the control system from the second output path back to the first output path.

14. The system of claim 8, wherein determining, by the control circuit and based on the second signal, an action to be performed by the computing device comprises:
generating a comparison result by comparing the second signal with one or more threshold status values;
determining a classification of liquid leakage from among a plurality of classifications of liquid leakage based on the comparison result, wherein each of the plurality of classifications of liquid leakage corresponds to one of the one or more threshold status values; and
determining the action that corresponds to the classification of liquid leakage to be performed by the computing device.

15. An apparatus comprising:
a sensing element coupled to at least a portion of a computing device;
a switch coupled to the sensing element, wherein the switch is configured to initially connect the sensing element to a first output path and then switch between the first output path and a second output path;
an analog-to-digital converter coupled to the second output path; and
a controller configured to:
receive a first signal generated based on data associated with the sensing element, wherein the first signal indicates that liquid leakage is detected in the computing device,
cause the switch that initially connects the sensing element to the first output path to switch from connecting to the first output path to connecting to the second output path,
receive a second signal generated by the analog-to-digital converter based on the data, and
determine, based on the second signal, an action to be performed by the computing device.

16. The apparatus of claim 15, wherein the apparatus further comprises an event-controller configured to generate the first signal in response to determining that a value of the data is below a threshold value, and wherein the event-controller is configured to maintain the first signal for a time period.

17. The apparatus of claim 15, wherein the apparatus further comprises an event-controller configured to generate the first signal, wherein the event-controller is configured to maintain the first signal for a time period, and wherein the event-controller is configured to generate a third signal that represents no detection of the liquid leakage in the computing device in response to determining that a value of the data is equal to or above a threshold value.

18. The apparatus of claim 15, wherein the sensing element comprises a liquid leakage sensor cable, and wherein the data comprises a resistance value of the liquid leakage sensor cable enclosed by a housing of the computing device.

19. The apparatus of claim 15, wherein the controller is further configured to cause the switch to switch from connecting to the second output path back to connecting to the first output path after determining the action to be performed by the computing device.

20. The apparatus of claim 15, wherein the controller is configured to:
generate a comparison result by comparing the second signal with one or more threshold status values;
determine a classification of liquid leakage from among a plurality of classifications of liquid leakage based on the comparison result, wherein each of the plurality of classifications of liquid leakage corresponds to one of the one or more threshold status values; and
determine the action that corresponds to the classification of liquid leakage to be performed by the computing device.
